(19) United States
(12) Patent Application Publication
(10) Pub. No.: US 2021/0183055 A1
(43) Pub. Date: Jun. 17, 2021

(54) METHODS AND SYSTEMS FOR ANALYZING DIAGNOSTIC IMAGES

(71) Applicant: GE Precision Healthcare LLC, Milwaukee, WI (US)

(72) Inventors: Gireesha Chinthamani Rao, Pewaukee, WI (US); Brijesh Chenan Veettil, Karnataka (IN); Katelyn Rose Nye, Glendale, WI (US); Mohamed Ali Hamadeh, Brookfield, WI (US); Christopher Scotto DiVetta, Hoboken, NJ (US)

(21) Appl. No.: 16/714,205

(22) Filed: Dec. 13, 2019

(51) Int. Cl. G06T 7/00

(52) U.S. Cl. CPC G06T 7/0012; G06T 2207/30004; G06T 2207/20081; G06T 2207/10116

(57) ABSTRACT

Various methods and systems are provided for analyzing medical images. In one example, a method includes determining a plurality of image quality metrics of a medical image of a subject, each image quality metric determined based on output from a respective image quality model, determining, based on the plurality of image quality metrics, whether the medical image should be rejected, and upon determining the medical image should be rejected, outputting a notification recommending the medical image be rejected.

### FIELD

Embodiments of the subject matter disclosed herein relate to a method for analyzing diagnostic images, and more specifically, to a method for analyzing diagnostic images to determine if the images should be rejected and new images obtained.

### BACKGROUND

Radiological medical imaging systems are often used to monitor, image, and diagnose a subject. During a typical radiology imaging session, a plurality of diagnostic images may be acquired. The images may be reviewed by a trained clinician, and the images that include desired anatomy and at sufficient image quality to support diagnosis may be saved as part of a patient exam that may be stored in long-term storage, for example.

### BRIEF DESCRIPTION

In one embodiment, a method includes determining a plurality of image quality metrics of a medical image of a subject, each image quality metric determined based on output from a respective image quality model, determining, based on the plurality of image quality metrics, whether the medical image should be rejected, and upon determining the medical image should be rejected, outputting a notification recommending the medical image be rejected.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows an example x-ray imaging system according to an embodiment;

FIG. 2 shows an example imaging system including an image processing system, according to an embodiment;

FIG. 3 is a flow chart illustrating a method for analyzing medical images to determine whether the images should be rejected or accepted, according to an embodiment;

FIG. 4 is an example graphical user interface including a notification recommending an image be rejected; and

FIG. 5 is another example graphical user interface including a notification recommending an image be rejected.

### DETAILED DESCRIPTION

The following description relates to various embodiments for medical imaging. In particular, systems and methods are provided herein for analyzing medical images to determine if the medical images are of sufficient quality to be included in a diagnostic exam, or if the medical images should be rejected and not included in the diagnostic exam. When diagnostic/medical imaging is performed on a patient to diagnose or rule out a condition, such as x-ray imaging to diagnose lung nodules, one or more images of one or more anatomical features of the patient may be acquired by an operator such as a technologist, and sometimes in more than one view (e.g., front view, side view, etc.). The images may be saved as part of an exam (e.g., on a picture archiving and communication system and/or as part of the patient's electronic medical record) that is reviewed by a clinician, such as a radiologist, who may enter one or more findings (e.g., presence of lung nodules) upon reviewing the images.

Various issues may cause one or more of the acquired images to be non-diagnostic, where the images are not of sufficient quality to facilitate clinician review/findings. These issues may include anatomical features of interest not being completely imaged, inadequate machine settings (such that images are not properly collimated or exposed), obstructions that may mask target anatomical features (such as jewelry, implanted medical devices, etc.), patient motion/blurring, and so forth. The technologist and/or reviewing clinician may opt to remove these non-diagnostic images from the final exam, but this process may disrupt technologist workflow, prolong the imaging duration, and expose patients to undue radiation. Further, if the images are rejected only once the reviewing clinician is viewing the images, if sufficient diagnostic images are not available, the patient may have to be reimaged, which may impose additional delays on arriving at a finding, which may negatively impact patient outcomes. Additionally, technologists have varying ability and experience, and thus across different technologists, different standards may be applied when deciding whether or not to reject an image, which can lead to inconsistent results. Even for the same technologist, images may not be consistently rejected or accepted, as technologists may occasionally be distracted, in a hurry, fatigued, etc.

Thus, medical facilities may institute various quality assurance protocols to ensure that the rate of rejected images is below a threshold rate. For example, a quality assurance protocol at a medical facility may dictate that a repeat reject analysis (RRA) be performed across all x-ray machines at the medical facility, where the RRA determines a ratio of rejected images to total acquired images. If the RRA results in a ratio that exceeds a threshold (e.g., 8-10%), various practices at the medical facility may be analyzed in order to determine if corrective action should be taken to lower the rate of rejected images.

However, determining the RRA ratio may be challenging. For example, each individual x-ray machine may store repeat reject data for that individual machine, and thus to determine a facility-wide RRA ratio, the repeat reject data from each machine has to be obtained, which may be time-consuming. Some quality assurance protocols include all acquired images being sent to a central storage location (e.g., a picture archiving and communication system, referred to as a PACS), with the determination of whether to reject the images being performed automatically at the central storage location. While these protocols may make facility-wide RRA easier, these protocols may suffer from selective data collection, where operators may choose to delete low-quality images from the machines directly, rather than have the low-quality images sent to the central storage location. Thus, to ensure an accurate RRA, individual machine-level data may still be needed.

Thus, according to embodiments disclosed herein, all images acquired by each x-ray machine in a given medical facility may be sent in real time to a local device configured to analyze each image and determine whether or not each image should be rejected. If the local device determines that an image should be rejected, an indication may be provided to the technologist or other clinician operating the x-ray machine on which that image was acquired, with the indication suggesting that a rejection may be considered, which may reduce disruptions to the technologist's workflow, reduce or prevent instances where the patient has to be re-imaged, and increase consistency across different x-ray machines and different technologists. In particular, the automatic rejection determination performed by the local device may act to provide training to novice technologists on which images should be rejected and which images have sufficient quality to be included in an exam for diagnostic purposes. The local device may then track the RRA ratio for each x-ray machine and determine a facility-wide RRA ratio.

To facilitate the determination of whether or not the acquired images should be rejected, a set of deep learning and/or machine learning algorithms may be stored and executed on the local device. The set of algorithms may work together to assess the quality of the x-ray acquisitions and appropriately alert technologists and/or radiologists if the x-ray acquisition needs to be rejected and repeated. Further, because each algorithm may be trained to determine if an image should be rejected for a specific reason (e.g., under or over exposure, clipped anatomy, obstructions, etc.), the recommendation to reject an image may be accompanied by a reason(s) for the rejection, based on which algorithm(s) identified that the image should be rejected. In doing so, the systems and methods provided herein may provide real-time notification to technologists if the image acquisitions that are in progress for a current imaging session/study should be rejected and repeated, which may decrease overall workflow for the technologist (including decreasing the duration of the imaging session), increase diagnostic quality of the images that are saved as part of the study/exam, and/or reduce patient radiation exposure. The systems and methods provided herein may also guide the technologist to record the most appropriate reason(s) for rejecting an image, which may be used to make decisions about future image acquisitions. For example, scan parameters used to acquire an image (such as x-ray machine settings including kV and mA) and patient parameters of the imaged patient (such as thickness, weight, height, age, etc.) may be saved along with reasons for rejecting the image, and this information may be used to train and/or entered as input to a scan parameter model that may be configured to notify the technologist of any adjustments that should be made to the current scan parameters to avoid further rejected images, thereby reducing radiation exposure to the patient by reducing the number of repeated image acquisitions.

The set of deep learning/machine learning algorithms may include algorithms that are trained to identify various issues that can lead to image rejection, such as an anatomy/patient positioning model that is trained to determine if one or more target anatomical features are sufficiently imaged, a collimation model trained to determine if suitable collimation was performed on the acquired images, an exposure model trained to determine if the images are under- or overexposed, etc. Further, a priors model may analyze the current image and one or more prior images to determine how “similar” the current image is to the prior image with respect to one or more parameters (e.g., exposure, patient positioning). The priors model may output a tolerance score that reflects how similar the current image is to a prior image, and if the tolerance score indicates image is not within a threshold similarity to the prior image (e.g., at least 85% similar), the image may be suggested for rejection. The output from each model may then be assessed, whether individually or collectively, to determine if an image should be rejected. If the output of the models indicates that an image should be rejected and reacquired, a notification may be output to the technologist/operator of the imaging system so that the technologist can decide whether or not to reject and reacquire the image.

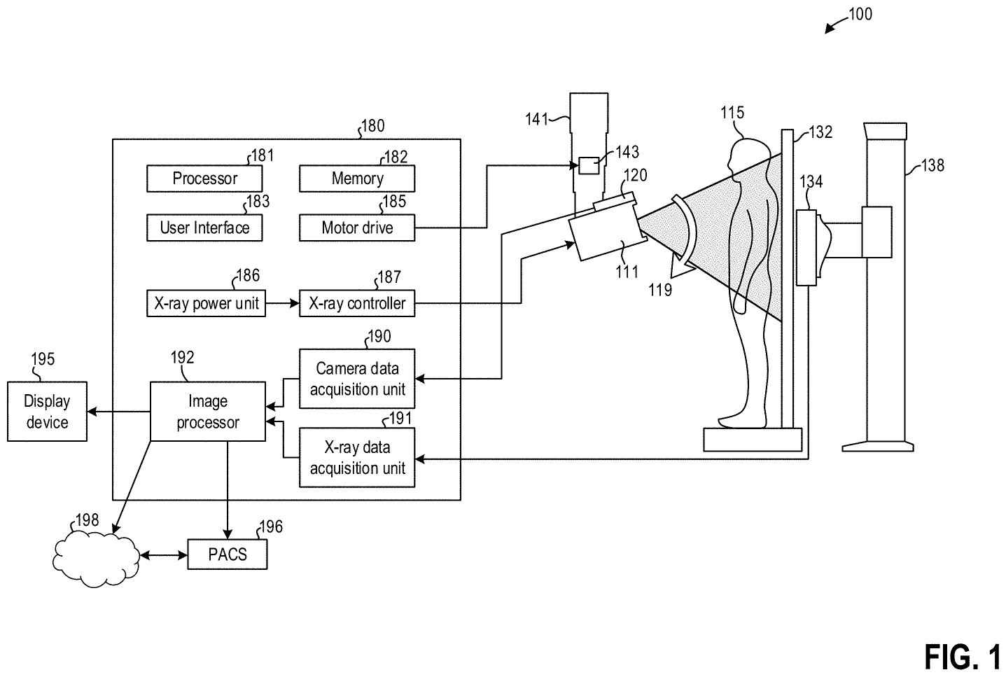

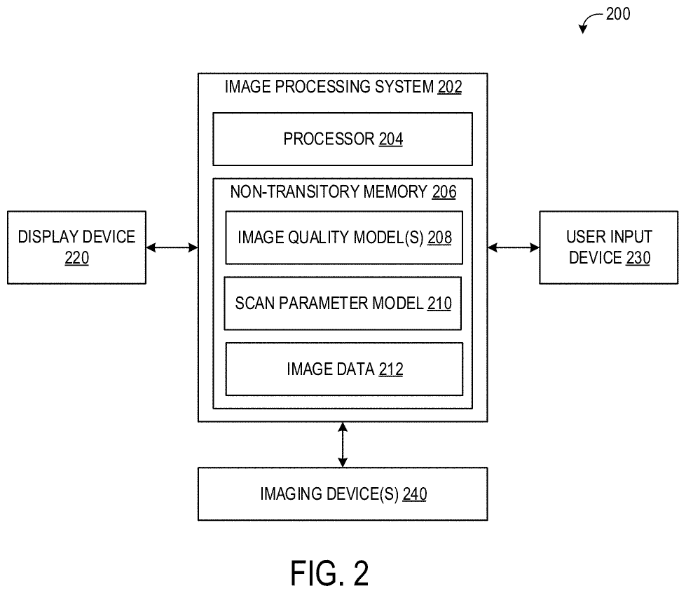

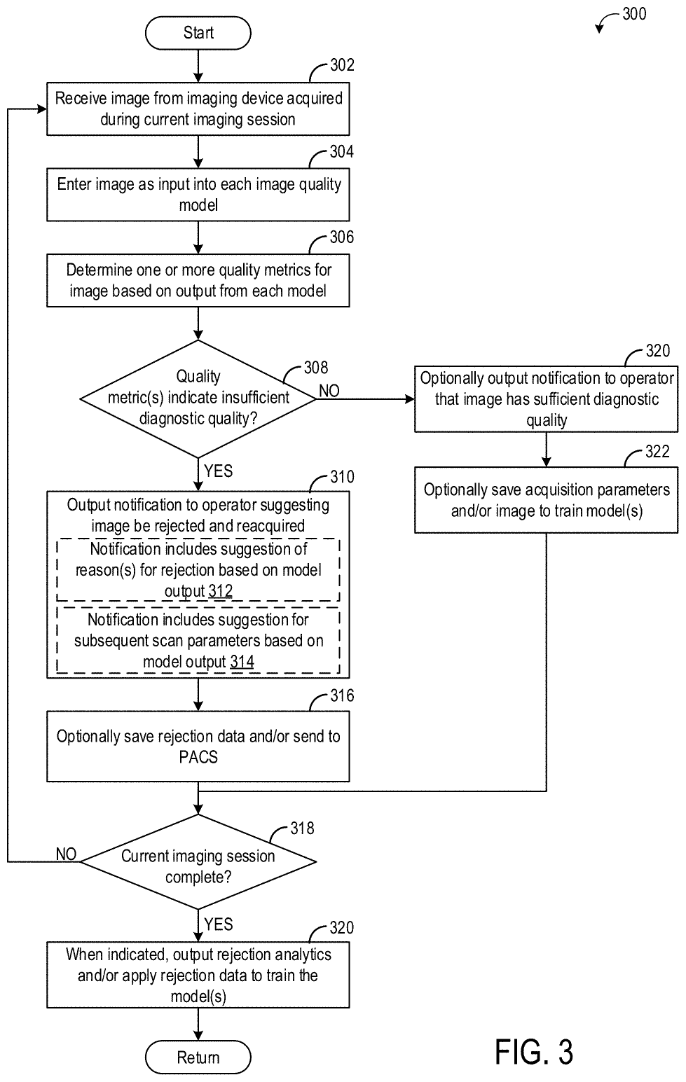

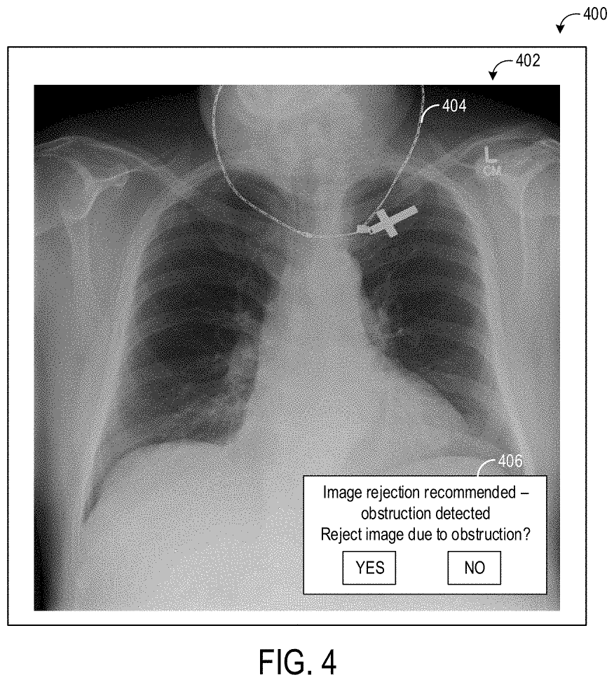

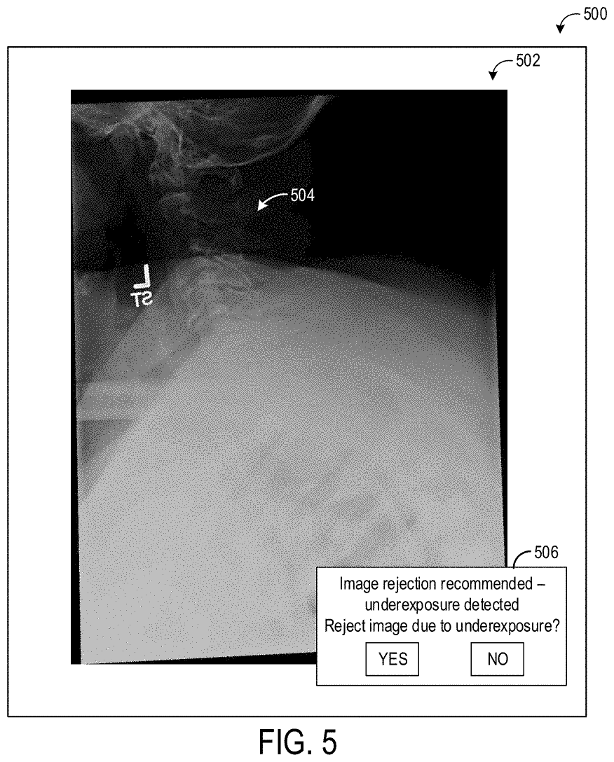

FIG. 1 depicts an x-ray imaging system that may be used to capture x-ray images in order to diagnose a patient condition. An imaging processing system, such as the image processing system shown in FIG. 2, may be communicatively coupled to the x-ray imaging system and may analyze images acquired by the x-ray imaging system, via a plurality of image quality models stored thereon, to determine whether the images should be rejected, according to the method shown in FIG. 3. If an image is determined to be a candidate for rejection, a notification may be output to an operator/technologist of the medical imaging system, such as via the graphical user interfaces as shown in FIGS. 4 and 5.

Turning now to FIG. 1, a block diagram of an x-ray imaging system 100 in accordance with an embodiment is shown. The x-ray imaging system 100 includes an x-ray source 111 which radiates x-rays, a stand 132 upon which the subject 115 stands during an examination, and an x-ray detector 134 for detecting x-rays radiated by the x-ray source 111 and attenuated by the subject 115. The x-ray detector 134 may comprise, as non-limiting examples, a scintillator, one or more ion chamber(s), a light detector array, an x-ray exposure monitor, an electric substrate, and so on. The x-ray detector 134 is mounted on a stand 138 and is configured so as to be vertically moveable according to an imaged region of the subject.

The operation console 180 comprises a processor 181, a memory 182, a user interface 183, a motor drive 185 for controlling one or more motors 143, an x-ray power unit 186, an x-ray controller 187, a camera data acquisition unit 190, an x-ray data acquisition unit 191, and an image processor 192. X-ray image data transmitted from the x-ray detector 134 is received by the x-ray data acquisition unit 191. The collected x-ray image data are image-processed by the image processor 192. A display device 195 communicatively coupled to the operating console 180 displays an image-processed x-ray image thereon.

The x-ray source 111 is supported by a support post 141 which may be mounted to a ceiling (e.g., as depicted) or mounted on a moveable stand for positioning within an imaging room. The x-ray source 111 is vertically moveable relative to the subject or patient 115. For example, one of the one or more motors 143 may be integrated into the support post 141 and may be configured to adjust a vertical position of the x-ray source 111 by increasing or decreasing the distance of the x-ray source 111 from the ceiling or floor, for example. To that end, the motor drive 185 of the operation console 180 may be communicatively coupled to the one or more motors 143 and configured to control the one or more motors 143.

The x-ray power unit 184 and the x-ray controller 182 supply power of a suitable voltage current to the x-ray source 111. A collimator (not shown) may be fixed to the x-ray source 111 for designating an irradiated field-of-view of an x-ray beam. The x-ray beam radiated from the x-ray source 111 is applied onto the subject via the collimator.

A camera 120 may be positioned adjacent to the x-ray source 111 and may be co-calibrated with the x-ray source 111. The camera 120 may comprise an optical camera that detects electromagnetic radiation in the optical range. Additionally or alternatively, the camera 120 may comprise a depth camera or range imaging camera. As an illustrative and non-limiting example, the camera 120 configured as a depth camera may include an optical camera, an infrared camera, and an infrared projector which projects infrared dots in the field-of-view of the camera 120. The infrared camera images the dots, which in turn may be used to measure depth within the optical camera of the camera 120. As another illustrative and non-limiting example, the camera 120 may comprise a time-of-flight camera. The camera 120 is communicatively coupled to the camera data acquisition unit 190 of the operation console 180. Camera data acquired or generated by the camera 120 may thus be transmitted to the camera data acquisition unit 190, which in turn provides acquired camera image data to the image processor 192 for image processing. For example, as described further herein, the image processor 192 may process the acquired camera images to identify a position of a desired anatomical region for imaging and/or to measure or estimate the thickness of the subject 115 at the desired anatomical region.

The x-ray source 111 and the camera 120 may pivot or rotate relative to the support post 141 in an angular direction 119 to image different portions of the subject 115.

In the depicted example, the image processor 192 is also in communication with a picture archiving and communications system (PACS) 196, which may in turn be in communication with one or more image processing systems 198. Image processing system 198 may be an edge device, such as an edge processing device, a cloud processing device, or another device. Image processing system 198 may be configured to implement an image quality analysis as discussed herein. In some embodiments, image processing system 198 may communicate directly with one or more medical imaging systems, such as directly communicating with the operation console 180/image processor 192, or may communicate with the medical imaging systems through an intermediate network, for example through another medical device data system or network. Image processing system 198 may be communicatively coupled to multiple x-ray imaging machines in addition to the operation console 180 of FIG. 1. For example, image processing system 198 may be located at a medical facility in which the x-ray imaging system 100 is located, and image processing system 198 may be connected (e.g., via a wireless connection) to one or more additional x-ray machines at the medical facility, where each additional x-ray machine includes an operation console storing an image processor configured to generate x-ray images based on x-ray data acquired from an x-ray detector in response to x-rays emitted from an x-ray source.

Referring to FIG. 2, a medical imaging system 200 is shown, in accordance with an exemplary embodiment. Medical imaging system 200 comprises image processing system 202, display device 220, user input device 230, and one or more imaging devices 240. In some embodiments, at least a portion of image processing system 202 is disposed at a device (e.g., edge device, server, etc.) communicably coupled to the medical imaging system 200 via wired and/or wireless connections. In some embodiments, at least a portion of image processing system 202 is disposed at a separate device (e.g., a workstation) which can receive images from the medical imaging system 200 from a storage device which stores the images generated by the medical imaging system 200. Medical imaging system 200 is a non-limiting example of x-ray imaging system 100, and thus image processing system 202 may be a non-limiting example of imaging processing system 198 and each imaging device 240 may be an x-ray imaging device that includes the same or similar components configured to acquire x-ray images, as described above with respect to FIG. 1 (e.g., an x-ray source, an x-ray detector, and an operation console including an x-ray controller, x-ray data acquisition unit, and image processor).

Image processing system 202 includes a processor 204 configured to execute machine readable instructions stored in non-transitory memory 206. Processor 204 may be single core or multi-core, and the programs executed thereon may be configured for parallel or distributed processing. In some embodiments, the processor 204 may optionally include individual components that are distributed throughout two or more devices, which may be remotely located and/or configured for coordinated processing. In some embodiments, one or more aspects of the processor 204 may be virtualized and executed by remotely-accessible networked computing devices configured in a cloud computing configuration.

Non-transitory memory 206 may store one or more image quality models 208, a scan parameter model 210, and image data 212. Each image quality model of the one or more image quality models 208 may include one or more machine learning models, such as deep neural networks comprising a plurality of weights and biases, activation functions, loss functions, and instructions for implementing the one or more machine learning models to determine a respective image quality metric for an input image. For example, the one or more image quality models 208 may include an anatomy model that is trained to determine if one or more target anatomical features are completely included in an input image, or if the one or more target anatomical features are clipped or otherwise not fully imaged in the input image; a collimation model trained to determine if an input image is correctly collimated; an exposure model trained to determine if an input image is over or under exposed; an obstruction model trained to determine if any obstructions are present in an input image (particularly with regard to one or more target anatomical features); a tilt model trained to determine if an input image is rotated or tilted with respect to a target orientation; and a source-image distance (SID) model trained to determine if the SID of an input image is in or out of a target range. Other image quality models are possible without departing from the scope of this disclosure, such as models to determine if the image is rotated or mirrored (horizontally or vertically flipped), lead annotation markers are missing (e.g., L for left or R for right), incorrect technique/protocol selected or used (e.g., wrong protocol used, like abdomen protocol used on chest, or grid used on suggested non-grid exam), image artifacts, patient motion/blur, etc.

The one or more image quality models 208 may include trained and/or untrained machine learning models and may further include various data, such as training data, training routines, or parameters (e.g., weights and biases), associated with one or more machine learning models stored therein. The one or more image quality models 208 may include instructions for training one or more of the models. In an example, the one or more image quality models 208 includes instructions for receiving training data sets from image data 212, which comprise pairs of medical images and corresponding ground truth labels, for use in training one or more of the image quality models. In some embodiments, the one or more image quality models 208 may be trained remotely, and thus the one or more image quality models 208 stored on image processing system 202 may not include instructions for training the models and/or image data usable to train the models. Non-transitory memory 206 may include instructions that, when executed by processor 204, cause image processing system 202 to conduct one or more of the steps of method 300, discussed in more detail below.

Non-transitory memory 206 may further include scan parameter model 212, which may include one or more machine learning models, such as deep neural networks, configured to determine scan parameters that may be applied to acquire a medical image of sufficient quality to be used in a diagnostic exam based on patient parameters (e.g., patent thickness). Scan parameter model 212 may store instructions for training the scan parameter model. In an example, the scan parameter model 210 includes instructions for receiving training data sets from image data 212, which comprise pairs of medical images and corresponding ground truth labels, for use in training the scan parameter model 210.

Non-transitory memory 206 may further store image data 212, such as medical images acquired by imaging device 240 that have been rejected by an operator of the imaging device 240 or accepted by an operator of the imaging device 240. The medical images stored in image data 212 may comprise x-ray images captured by an x-ray system (in embodiments in which imaging device 240 is an x-ray imaging device), computed tomography (CT) images captured by a CT imaging system (in embodiments in which imaging device 240 is a CT imaging device), and/or one or more other types of imaging data. For example, image data 212 may include medical images (e.g., x-ray images) and corresponding ground truth labels (e.g., image rejected or accepted, scan parameters used to acquire the image, and, when the image was rejected, the reason for the image rejection, such as whether or not target anatomical features are clipped, whether or not collimation is correct, whether or not the image is under or over exposed, whether or not any obstructions are present in the image, the angle of rotation or tilt of the image, the SID of the image, etc.), which may be stored in an ordered format, such that a medical image of a subject is associated with a ground truth label of the same image of the same subject. The ground truth labels may be manually entered by an expert (e.g., a radiologist or senior technologist) and/or automatically generated (e.g., in the case of labels indicating whether the image was accepted or rejected and/or in the case of labels indicating scan parameters used to acquire the image). In an example, the tilt model may be trained to determine if an input image is rotated or tilted with respect to a target orientation via images that have ground truth labels indicating if the image is rotated or not rotated, where an image is considered to be rotated if it is rotated by more than +/−45°. Images that are determined to be rotated (e.g., after the model is deployed) may be corrected to be rotated closer to 0°. In some examples, there may be four classes of rotation within 360 degrees, e.g., −45 to +45, and so on around the circle.

As explained above, the training data used to train the image quality models and/or scan parameter model may be acquired from previously rejected and accepted images. At least some of the ground truth labels may be generated automatically (e.g., by the image processing system 202 and/or a separate device on which the model training is performed), in order to reduce radiologist/technologist burden, expedite the training process, and generate more training data than may be possible when relying on expert annotations to generate the ground truth labels. However, at least some of the ground truth labels may include or be dependent on the intent of the image. The intent of the image may include the reason the image was obtained, such as the image being obtained as part of a chest x-ray exam, as part of an x-ray exam intended to image the sternum, or other type of exam. For example, in order to generate a ground truth label indicating that a given image includes a target anatomy being clipped, the target anatomy has to be identified as being the anatomy that was intended to be imaged. In some examples, the intent of the image may be determined automatically (e.g., by the image processing system 202 and/or a separate device) based on anatomy identification, and the amount of the anatomy present in the image. As an example, if an image includes at least 50% of each lung, the intent of that image may be determined to be a chest/lung x-ray, which may be included in a ground truth label to flag to the one or more image quality models that the lungs are the intended target anatomy. In this way, when the one or more image quality models are trained, the training may ensure that the models are equipped to determine the proper target anatomy. When the one or more image quality models are deployed after training, the input images may be analyzed (e.g., via one or more of the image quality models) to identify the intent of the image, and the intent of the image may be used with the input image to determine if the target anatomy is fully imaged. By doing so, exams intended to image the spine or clavicle, for example, which may include some but not all of the lungs (and where the presence or absence of the lungs may not impact the diagnostic quality of the images), will not be misidentified as having clipped anatomy.

In some embodiments, the non-transitory memory 206 may include components disposed at two or more devices, which may be remotely located and/or configured for coordinated processing. In some embodiments, one or more aspects of the non-transitory memory 206 may include remotely-accessible networked storage devices configured in a cloud computing configuration.

Medical imaging system 200 further includes imaging device 240, which may comprise substantially any type of medical imaging device, including x-ray, magnetic resonance imaging (MRI), CT, positron emission tomography (PET), hybrid PET/MR, ultrasound, etc. Medical imaging system 200 may further include user input device 230. User input device 230 may comprise one or more of a touchscreen, a keyboard, a mouse, a trackpad, a motion sensing camera, or other device configured to enable a user to interact with and manipulate data within image processing system 202.

Display device 220 may include one or more display devices utilizing virtually any type of technology. In some embodiments, display device 220 may comprise a computer monitor, and may display medical images, ground truth labels, output from the one or more image quality models and/or scan parameter model, etc. Display device 220 may be combined with processor 204, non-transitory memory 206, and/or user input device 230 in a shared enclosure, or may be a peripheral display device and may comprise a monitor, touchscreen, projector, or other display device known in the art, which may enable a user to view medical images reconstructed from measurement data acquired by imaging device 240, and/or interact with various data stored in non-transitory memory 206.

It should be understood that medical imaging system 200 shown in FIG. 2 is for illustration, not for limitation. Another appropriate medical imaging system may include more, fewer, or different components. As explained above, medical imaging system 200 may include one or more image quality models and/or a scan parameter model, which may be machine learning/deep learning models that are trained locally or remotely. When trained locally, the one or more image quality models and/or scan parameter model may be trained based on image data and/or ground truth labels that are generated at the same facility as the medical imaging system 200. In this way, preferences of the technologists/radiologists at that facility may be reflected in the one or more image quality models and/or scan parameter model. In other examples, the one or more image quality models and/or scan parameter model may be trained remotely, and may be trained using image data and/or ground truth labels generated at one or more other facilities. These remotely-trained models may be deployed at multiple facilities, which may increase consistency of image rejection in a more global manner.

FIG. 3 shows a method 300 for analyzing medical images to determine if the images should be rejected or if the images are of acceptable quality to be included in a diagnostic exam. Method 300 may be carried out according to instructions stored in non-transitory memory of a computing device, such as image processing system 198 and/or image processing system 202.

At 302, an image of a subject is received from an imaging device, where the image is acquired during a current imaging session of the subject. For example, the imaging device may be an x-ray imaging device. Once an image is acquired with the x-ray device, the image may be sent from the imaging device to the computing device, for example to the image processing system 198 and/or imaging processing system 202. The image may be sent to the computing device while the current imaging session is active, e.g., while the patient is still positioned at the imaging device and/or before an operator of the imaging device has terminated the current imaging session. In this way, the image is sent as part of an ongoing, active imaging session and is not sent once the imaging session is over.

At 304, the image is input into each image quality model of a plurality of image quality models. The plurality of image quality models may include one or more of the image quality models 208 discussed above with respect to FIG. 2. For example, the plurality of image quality models may include an anatomy model that is trained to determine if one or more target anatomical features are completely included in an input image, or if the one or more target anatomical features are clipped or otherwise not fully imaged in the input image; a collimation model trained to determine if an input image is correctly collimated; an exposure model trained to determine if an input image is over or under exposed; an obstruction model trained to determine if any obstructions are present in an input image (particularly with regard to one or more target anatomical features); a tilt model trained to determine if an input image is rotated or tilted with respect to a target orientation; and a source-image distance (SID) model trained to determine if the SID of an input image is in or out of a target range. In some examples, the intent of the image may be determined prior to being entered into the one or more image quality models and/or one or more of the image quality models may be further configured to determine the intent of the image. The intent of the image may be used to identify the target anatomy intended to be imaged, which the anatomy model may use, for example, to determine if the target anatomy is clipped or is fully present.

Each image quality model may generate a respective model output upon the image being input to the image quality model. Each model output may include a value (e.g., on a scale from 1-10 or 1-100) that indicates a level of confidence that the image is of sufficient diagnostic quality to be included in an exam. For example, the anatomy model may generate a model output of a value in the range of 1-100, with a value of 1 indicating low confidence that the image is of sufficient diagnostic quality (e.g., low confidence that one or more target anatomical features are present in the image) and a value of 100 indicating high confidence that the image is of sufficient diagnostic quality (e.g., high confidence that one or more target anatomical features are present in the image). In other examples, the model output may include a binary indication of whether the image is of sufficient diagnostic quality, such as a diagnostic/non-diagnostic (or reject/accept) indication.

At 306, one or more quality metrics are determined for the image based on the output from each image quality model. In one example, the one or more quality metrics may be the respective model outputs discussed above. For example, a first quality metric may be the model output generated by the anatomy model, a second quality metric may be the model output generated by the collimator model, a third quality metric may be the model output generated by the exposure model, etc. In other examples, the one or more quality metrics may include a summation or average of some or all of the model outputs (e.g., each confidence value may be summed or the confidence values may be averaged to arrive at a quality metric). In some examples, a first quality metric may include the model output from the anatomy model and a second quality metric may include a summation or average of two or more other models outputs, such as the outputs from the collimation model and the exposure model. Other quality metrics based on the model outputs are possible.

At 308, method 300 determines if the quality metric(s) indicate the image has insufficient diagnostic quality. For example, each quality metric may be compared to a respective quality threshold, and if any of the quality metrics is below the corresponding quality threshold, insufficient diagnostic quality may be indicated. For example, the first quality metric may be the output of the anatomy model, which may be a value in the range of 1-100. If the anatomy model output is less than a threshold value (e.g., 70), the image may be determined to be of insufficient diagnostic quality. In some examples, each quality metric may be compared to the same quality threshold. In other examples, two or more of the quality metrics may be compared to different quality thresholds. For example, the first quality metric (e.g., the output of the anatomy model) may be compared to a first quality threshold and a second quality metric (e.g., the output of the exposure model) may be compared to a second quality threshold that is different (e.g., lower) than the first quality threshold. In doing so, different quality metrics/model outputs may be given different importance/weight in determining whether an image is of insufficient diagnostic quality.

In examples where the model outputs include a binary diagnostic/non-diagnostic (or reject/accept) indication, if any of the model outputs indicate that the image is non-diagnostic or should be rejected, the image may be indicated as being of insufficient diagnostic quality. In other examples, more than one quality metric indicating the image is of insufficient diagnostic quality may be needed before the image is indicated as having insufficient diagnostic quality, other than the model output from the anatomy model. For example, if the anatomy model indicates the target anatomy is not adequately imaged in the image, the image may be deemed of insufficient diagnostic quality regardless of the other model outputs/quality metrics. However, if the anatomy model indicates the target anatomy is adequately imaged, the remaining model outputs/quality metrics may be analyzed individually or collectively to determine if the image is of insufficient diagnostic quality, and the decision of whether the remaining model outputs/quality metrics are analyzed individually or collectively may be based on the model outputs themselves. For example, if the model output from the exposure model indicates the image is slightly underexposed, the image may be determined to be of sufficient diagnostic quality if all the other model outputs/quality metrics indicate the image is of sufficient diagnostic quality. However, if the anatomy/patient positioning model output also indicates a relatively small or intermediate issue and there is slight patient motion, the image may be determined to be of insufficient diagnostic quality due to the combination of slight underexposure and small to intermediate patient position and patient motion blur issues. In another example, if the severity of one model output is relatively low, e.g., an obstruction of a small button that occludes 0.5% of the image area, the image may be deemed to have sufficient image quality, but a larger severity of the model output (e.g., an obstruction of 7% of the image area from a cell phone in the patient's pocket) may indicate the image is not of sufficient diagnostic quality.

If the quality metric(s) indicate the image is of insufficient diagnostic quality, method 300 proceeds to 310 to output a notification to the operator of the imaging device suggesting the image should be considered for rejection and the image be reacquired. The notification may include a visual notification, such as a dialog box or pop-up displayed on a display device of the imaging device. In other examples, additionally or alternatively, the notification may include an audio notification output from a loudspeaker (e.g., associated with the imaging device), such as a voice output suggesting the image be considered for rejection. Because the notification is to be output to the operator of the imaging device, which may be located in a different room of a medical facility than the imaging device, outputting the notification may include generating the notification and sending the notification to the imaging device. The imaging device may then receive the notification and output the notification on the display device of the imaging device. For example, the imaging processing system 198 may receive the image from the image processor 192 and/or operation console 180, enter the image into each image quality model stored on the image processing system 198, determine the image is of insufficient image quality based on the output of the image quality models, generate a notification suggesting the operator reject and reacquire the image, and send the notification to the operation console 180. The operation console 180 may output the notification for display on display device 195. In other examples, the image processing system 198 may be configured to send the notification directly to the display device 195.

In some examples, outputting the notification may include outputting a notification including a suggestion of the reason(s) for the rejection based on the model output, as indicated at 312. For example, if the model output from the anatomy model indicates the target anatomy was not adequately imaged, the notification may include an indication that the target anatomy was not adequately imaged. In some examples, more detailed reasoning may be provided, such as an indication that a certain region of the anatomy was not included (e.g., the top 25% of the target anatomy was clipped and not included in the image).

In some examples, outputting the notification may include outputting a notification including a suggestion for subsequent scan parameters based on the model output, as indicated at 314. When the image is determined to be of insufficient diagnostic quality, the operator may reject the image and then acquire a new image. To increase the likelihood that the new image will be of sufficient diagnostic quality, the notification may include one or more suggestions for how the image acquisition parameters may be adjusted to obtain a higher quality image. The suggestion for subsequent scan parameters may include a suggestion for an adjustment to the imaging device settings, such as an adjustment to an x-ray source (e.g., current and/or voltage), collimator, etc. Additionally or alternatively, the suggestion for subsequent scan parameters may include a suggestion for an adjustment to patient positioning, a suggestion to remove detected obstructions, or another suggestion. The suggestion for the subsequent scan parameters may be based on the model outputs. For example, if the anatomy model output indicates that a portion of the target anatomy is clipped, the suggestion may include a suggestion to move the x-ray source/detector relative to the patient in a certain direction and/or by a certain amount. If the exposure model output indicates that the image is underexposed, the suggestion may include a suggestion to adjust the x-ray technique to increase the exposure.

In some examples, rather than (or in addition to) outputting the notification including the suggestion for the subsequent scan parameters, the method may include outputting a command to the imaging device to automatically change one or more scan parameters. For example, if the image is rejected because target anatomy is clipped in the image (e.g., the bottom of the lungs was clipped), the command may include a command to adjust an angle or a position of the x-ray machine (e.g., the x-ray source and/or detector) in order to include all of the target anatomy in the next image.

Further, in some examples, additional patient information may be used to generate the suggestion for the subsequent scan parameters. For example, patient height, patient thickness, estimated position of target anatomy, etc., may be determined based on the patient's electronic medical record, based on operator input, and/or based on vision information (e.g., obtained from a visible light and/or depth camera). The suggestion(s) for the subsequent scan parameters may take into account the patient information, which may result in more accurate adjustments to the scan parameters. As one non-limiting example, when the x-ray technique is adjusted to reach a desired level of exposure, the x-ray technique adjustment may be based in part of the patient thickness, which may affect the brightness of the image due to the level of x-ray attenuation provided by the patient.

In some examples, the suggestion(s) for the subsequent scan parameters may be output by a scan parameter model, such as scan parameter model 210 described above with respect to FIG. 2. The scan parameter model may use the image and/or or the model outputs as inputs to generate the subsequent scan parameters. In some examples, the scan parameter model may also use the scan parameters used to acquire the image (e.g., the x-ray technique, position of the x-ray source/detector, etc.) as inputs to generate the subsequent scan parameters. In some examples, the scan parameter model may also use the patient information as input to generate the subsequent scan parameters.

At 316, method 300 optionally includes saving rejection data and/or sending rejection data to an associated image storage system, such as a PACS. The rejection data may include the rejected image, the reason(s) for the rejection, the scan parameters used for the image acquisition, and/or the operator action taken in response to the recommendation to reject the image. For example, if the operator chooses to reject the image, the rejected image may be saved along with the reasons for the rejection. This information may be used by the radiologist who reviews the exam after the exam is completed. For example, if the radiologist disagrees with the decision to reject the image, the radiologist may enter user input indicating that they disagree with rejection, and why, which may be forwarded to the computing device for continued image quality model learning. If the operator chooses to instead accept the image and not reacquire the image, that may also be saved and forwarded to the radiologist. Further, the recommendation to reject, the reasons for the rejection, and the image acquisition parameters may be used to train the scan parameter model. Additionally, the rejection data may be used at the PACS to inform a PACS-based image quality model (which may do a secondary check on diagnostic quality), assist in compiling statistics on the RRA, be saved as part of the patient's exam (along with all other accepted images in the current imaging session), and so forth.

At 318, method 300 determines if the current imaging session is complete. The current imaging session may be determined to be complete if a notification is received (e.g. from the imaging device) indicating that the session is complete. In another example, the session may be determined to be complete in response to a new image being received from the imaging device, with the new image being of a different subject and/or a different exam type than the current image. If the imaging session is not complete, method 300 returns to 302 to receive a subsequent image. If the imaging session is complete, method 300 proceeds to 320, where rejection analytics may be output when indicated, and/or the rejection data (e.g., the rejected image, reason(s) for the rejection, the scan parameters used for the image acquisition, and/or the operator action taken in response to the recommendation to reject the image) may be applied to train the model(s), such as the scan parameter model and/or the one or more image quality models. The rejection analytics may include a calculation of an RRA rate for the specific imaging device and/or for a larger area (e.g., the department or the entire medical facility). The RRA rate may be a measurement of the number of rejected images per total number of acquired images, and may be calculated over a specified duration (e.g., the last day, the last week, the last month, etc.). The rejection data may include the rejection data for the image as described above as well as rejection data for other images (e.g., from the imaging device and/or other imaging devices). In this way, at least in some examples, the models may continue to learn after being deployed, which may assist in fine-tuning the models to radiologist preferences, facility preferences, specific patient populations, etc. Method 300 then returns.

Returning to 308, if the quality metric(s) do not indicate insufficient diagnostic quality (e.g., if the image is determined to be of sufficient diagnostic quality), method 300 proceeds to 320 to optionally output a notification to the operator that the image has sufficient diagnostic quality. In doing so, the operator may be given an increased level of confidence that the image is suitable for inclusion in the exam, which may be helpful when the operator is relatively new. However, in some examples, when the image is determined to be of sufficient diagnostic quality, no notification may be output, which may help in minimizing operator cognitive load/notification fatigue. At 322, method 300 optionally includes saving the image acquisition scan parameters and/or the image, which may be used to train the models when indicated. Method 300 then proceeds to 318 to determine if the imaging session is complete.

Thus, method 300 provides for determining a plurality of image quality metrics of a medical image of a subject, where each image quality metric is determined based on output from a respective image quality model. Further, based on the plurality of image quality metrics, method 300 may determine whether the medical image should be rejected. If method 300 determines that the medical image should be rejected, a notification may be output (e.g., sent to a display device associated with the medical imaging device that acquired the medical image) recommending the medical image be rejected. However, in some examples, rather than outputting a notification recommending the image be rejected, method 300 may instead automatically reject the image, which may further expedite the imaging session. When an image is automatically rejected, that image is not included in the final exam and the image may be deleted entirely, or the image may be saved as part of the rejection data discussed above.

While method 300 was described above as being implemented on an image processing system in communication with a medical imaging device, it should be understood that the image processing system may be in communication with a plurality of medical imaging devices, and may receive medical images from each medical imaging device. The steps described herein (e.g., evaluating the diagnostic quality of the images and recommending to reject based on the diagnostic quality) may be performed for each received image. Further, the image processing system may track a repeat reject analysis rate, and may update the RRA rate with each received image, based on whether or not each image was rejected. Thus, in some examples, the image processing system may receive a notification each time an image is actually rejected.

Each medical imaging device may be configured (e.g., store instructions in memory executable by a processor) to send each acquired image to the image processing system, receive a notification from the image processing system if an acquired image is determined to be of insufficient diagnostic quality (and thus is recommended to be rejected), and output the notification for display. Upon receiving a user input confirming the image should be rejected, the medical imaging device may reject the image. When a medical image is rejected, that image is not included as part of an exam. The rejected image may be permanently deleted or moved to another location (e.g., the PACS, or in a reject folder) so that rejection analytics/training may be performed using the rejected image.

Additionally, as explained above, the notification may include suggestions for one or more scan parameter adjustments for acquisition of a subsequent image. When a notification is received that includes suggestions for one or more scan parameter adjustments, an additional notification may be displayed asking the operator to confirm if the suggested scan parameter adjustments should be implemented, or a scan parameters interface may be displayed via which the operator may adjust one or more scan parameters. In some examples, the medical imaging device may receive a command to adjust one or more scan parameters from the image processing system, and may adjust the one or more scan parameters in response to receiving the command.

FIG. 4 shows an example graphical user interface 400 that may be output on a display device of an imaging device (e.g., display device 195). Interface 400 includes an image 402. Image 402 is an x-ray image acquired as part of a patient chest x-ray exam to diagnose a condition (e.g., lung nodules). Image 402 includes an obstruction 404, herein a necklace worn by the patient. When image 402 is entered as input to the one or more image quality models described herein, image 402 may be determined to be of insufficient diagnostic quality due at least in part to the obstruction. Thus, a notification 406 may be output on the interface 400. Notification 406 includes a suggestion to reject the image, along with the suggested reason for the rejection (the obstruction). Additionally, notification 406 includes a request to reject the image due to the detected obstruction and two user interface control buttons, a yes button and a no button. The operator may enter user input (e.g., touch input, mouse click, etc.) selecting one of the control buttons. If the user selects yes, the image may be automatically rejected. By presenting the recommendation to reject along with the reason(s) for the rejection via a notification that is output automatically upon the image being acquired and the diagnostic quality assessed by the image quality models, the operator may reject the image with only a single input, which may reduce the workload for the operator and increase the efficiency of the operator's interaction with the imaging device and associated display device.

In some examples, if the operator selects no when presented with the notification 406, the image may be automatically accepted (e.g., saved as part of the patient exam). In other examples, in response to the operator selecting no, one or more additional notifications may be displayed, which may allow the operator to reject the image but for a different reason or to provide an explanation as to why the image is not being rejected.

FIG. 5 shows another example graphical user interface 500 that may be output on a display device of an imaging device (e.g., display device 195). Interface 500 includes an image 502. Image 502 is a lateral c-spine x-ray image. Image 502 is underexposed, leading to areas (e.g., at arrow 504) where anatomical features are not sufficiently imaged. When image 502 is entered as input to the one or more image quality models described herein, image 502 may be determined to be of insufficient diagnostic quality due at least in part to the underexposure. Thus, a notification 506 may be output on the interface 500. Notification 506 includes a suggestion to reject the image, along with the suggested reason for the rejection (the underexposure). Additionally, notification 506 includes a request to reject the image due to the detected obstruction and two user interface control buttons, a yes button and a no button. The operator may enter user input (e.g., touch input, mouse click, etc.) selecting one of the control buttons. If the user selects yes, the image may be automatically rejected. If the operator selects no when presented with the notification 506, the image may be automatically accepted (e.g., saved as part of the patient exam), or one or more additional notifications may be displayed, which may allow the operator to reject the image but for a different reason or to provide an explanation as to why the image is not being rejected.

A technical effect of applying one or more image quality models to assess a diagnostic quality of an image and recommend the image be rejected if the one or more image quality models determine the image is of insufficient diagnostic quality is reduction of overall workflow for the technologist (including decreasing the duration of the imaging session), increase of diagnostic quality of the images that are saved as part of an study/exam, increase of diagnostic consistency across multiple exams, and reduction of patient radiation exposure.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method, comprising:
determining a plurality of image quality metrics of a medical image of a subject, each image quality metric determined based on output from a respective image quality model;
determining, based on the plurality of image quality metrics, whether the medical image should be rejected; and
upon determining the medical image should be rejected, outputting a notification recommending the medical image be rejected.

2. The method of claim 1, further comprising determining one or more reasons why the medical image should be rejected based on each image quality metric, and wherein outputting the notification includes outputting the notification including the one or more reasons why the medical image should be rejected.

3. The method of claim 1, further comprising determining one or more scan parameters to be adjusted for a subsequent image acquisition of the subject, and wherein outputting the notification includes outputting the notification including the one or more scan parameters to be adjusted.

4. The method of claim 3, wherein determining the scan parameters to be adjusted comprises entering one or more scan parameters used to acquire the medical image and one or patient parameters of the subject into a scan parameter model.

5. The method of claim 3, wherein determining the scan parameters to be adjusted comprises determining the scan parameters to be adjusted based on each image quality metric.

6. The method of claim 3, wherein determining the scan parameters to be adjusted comprises determining the scan parameters to be adjusted responsive to determining the medical image should be rejected.

7. The method of claim 3, wherein the medical image is an x-ray image acquired by an x-ray imaging system, and wherein the scan parameters comprise one or more of a position or angle of an x-ray source and/or detector relative to the subject, an x-ray source voltage, and x-ray source current.

8. The method of claim 1, wherein determining the plurality of image quality metrics of the medical image comprises:
determining a first image quality metric based on output from an anatomy model trained to determine if one or more target anatomical features are completely included the medical image,
determining a second image quality metric based on output from a collimation model trained to determine if the medical image is correctly collimated;
determining a third image quality metric based on output from an exposure model trained to determine if the medical image is over or under exposed;
determining a fourth image quality metric based on output from an obstruction model trained to determine if any obstructions are present in the medical image;
determining a fifth image quality metric based on output from a tilt model trained to determine if the medical image is rotated or tilted with respect to a target orientation; and/or
determining a sixth image quality metric based on output from a source-image distance (SID) model trained to determine if the SID of the medical image is within a target range.

9. The method of claim 8, wherein determining, based on the plurality of image quality metrics, whether the medical image should be rejected comprises determining that the medical image should be rejected in response to any of the first, second, third, fourth, fifth, and/or sixth image quality metrics indicating that the medical image is of insufficient diagnostic quality.

10. The method of claim 9, further comprising determining whether any of the first, second, third, fourth, fifth, and/or sixth image quality metrics indicates that the medical image is of insufficient diagnostic quality based on whether any of the first, second, third, fourth, fifth, and/or sixth image quality metrics meets a predetermined condition relative to a respective quality threshold.

11. A system, comprising:
an image processing system configured to be communicatively coupled to at least a first medical imaging device, the image processing system including a memory storing instructions and a processor, that when executing the instructions, is configured to:
determine a plurality of image quality metrics of a medical image of a subject, the medical image received from the first medical imaging device, each image quality metric determined based on output from a respective image quality model;
determine, based on the plurality of image quality metrics, whether the medical image is of sufficient or insufficient diagnostic quality; and
upon determining the medical image is of insufficient diagnostic quality, send a notification, to the first medical imaging device, recommending the medical image be rejected.

12. The system of claim 11, wherein the memory stores a repeat reject analysis rate, and the processor, when executing the instructions, is configured to update the repeat reject analysis rate upon receiving a notification that the medical image was rejected.

13. The system of claim 12, wherein the repeat reject analysis rate comprises a proportion of all acquired medical images, from each medical imaging device communicatively coupled to the image processing system, that were rejected.

14. The system of claim 11, wherein the memory stores:
a first image quality model trained to trained to determine if one or more target anatomical features are included the medical image;
a second image quality model trained to determine if the medical image is correctly collimated;
a third image quality model trained to determine if the medical image is over or under exposed;
a fourth image quality model trained to determine if any obstructions are present in the medical image;
a fifth image quality model trained to determine if the medical image is rotated or tilted with respect to a target orientation; and/or
a sixth image quality model trained to determine if a source-image distance of the medical image is within a target range.

15. A method, comprising:
determining a plurality of image quality metrics of an x-ray image of a subject, each image quality metric determined based on output from a respective image quality model, the x-ray image received from an x-ray machine;
determining, based on the plurality of image quality metrics, that the x-ray image should be rejected;
determining, based on the plurality of image quality metrics, one or more reasons why the medical image should be rejected; and
upon determining the x-ray image should be rejected, sending, to the x-ray machine, a notification recommending the x-ray image be rejected, the notification including the one or more reasons why the x-ray image should be rejected.

16. The method of claim 15, further comprising determining one or more scan parameters of the x-ray machine to be adjusted for a subsequent image acquisition of the subject, and wherein outputting the notification includes outputting the notification including the one or more scan parameters to be adjusted.

17. The method of claim 16, wherein the scan parameters comprise one or more of a position or angle of an x-ray source and/or detector of the x-ray machine relative to the subject, an x-ray source voltage, and x-ray source current.

18. The method of claim 15, wherein determining the plurality of image quality metrics of the x-ray image comprises:
determining a first image quality metric based on output from an anatomy model trained to determine if one or more target anatomical features are included the x-ray image,
determining a second image quality metric based on output from a collimation model trained to determine if the x-ray image is correctly collimated;
determining a third image quality metric based on output from an exposure model trained to determine if the x-ray image is over or under exposed;
determining a fourth image quality metric based on output from an obstruction model trained to determine if any obstructions are present in the x-ray image;
determining a fifth image quality metric based on output from a tilt model trained to determine if the x-ray image is rotated or tilted with respect to a target orientation; and/or
determining a sixth image quality metric based on output from a source-image distance (SID) model trained to determine if the SID of the x-ray image is within a target range.

19. The method of claim 18, wherein determining that the x-ray image should be rejected comprises determining that the x-ray image should be rejected in response to any one of the first, the second, the third, the fourth, the fifth, and/or the sixth image quality metric being below a respective quality threshold.

20. The method of claim 15, further comprising updating a repeat reject analysis rate based on whether the x-ray image is rejected by an operator of the x-ray machine.
